(19) United States
(12) Patent Application Publication
(10) Pub. No.: US 2016/0013625 A1
(43) Pub. Date: Jan. 14, 2016

(54) WIRE HARNESS

(71) Applicant: SUMITOMO WIRING SYSTEMS, LTD., Yokkaichi-shi, Mie (JP)

(72) Inventors: Yoshie SUZUKI, Mie (JP); Yasuhiro KAJIWARA, Mie (JP)

(73) Assignee: SUMITOMO WIRING SYSTEMS, LTD., Mie (JP)

(21) Appl. No.: 14/760,362

(22) PCT Filed: Nov. 7, 2013
(86) PCT No.: PCT/JP2013/080079

§ 371 Date: Jul. 10, 2015

(30) Foreign Application Priority Data
Jan. 31, 2013 (JP) 2013-016393

(51) Int. Cl. H02G 3/04; B60R 16/02

(52) U.S. Cl. CPC H02G 3/0468; B60R 16/0215

(57) ABSTRACT

The present invention has as an object to provide a protective member which is capable of attaching to a wire harness having various outer diameters with as little jostling as possible, and which has excellent path maintenance ability. The protective member covers and protects an outer circumference of a wire harness main body. The protective member is formed in a shape covering at least a portion of the outer circumference of the wire harness main body and having an opening formed in a portion of the outer circumference. The protective member is formed by hot-pressing a nonwoven member and is sufficiently elastic to enable flexure deformation toward inner and outer circumferences. Preferably, an outer circumference portion of the protective member is more pliant than an inner circumference portion of the protective member.

### FIELD OF THE INVENTION

The present invention relates to a technology that protects and maintains a path of a wire harness main body.

### BACKGROUND OF THE INVENTION

Conventionally, technologies disclosed in Patent Literatures 1 to 3 are examples of members protecting a wire harness main body.

Patent Literature 1 discloses a technology that protects a corrugated tube between a receiver tube having an arced shape in cross-section and a receiver tube having a “U” shape in cross-section.

Patent Literature 2 discloses a protector that includes a pair of half members forming a tube shape. The half members are provided with a pair of temporary fixation ribs, which can be displaced in an inward/outward direction.

Patent Literature 3 discloses forming a protective material that is open on a top surface using a dip-molded article.

### RELATED ART

### Patent Literature

Patent Literature 1: Japanese Patent Laid-open Publication No. 2004-135436

Patent Literature 2: Japanese Patent Laid-open Publication No. 2008-278724

Patent Literature 3: Japanese Patent Laid-open Publication No. 2012-115043

### SUMMARY OF THE INVENTION

### Problems to Be Solved by the Invention

However, in Patent Literature 1, when an outer diameter of the wire harness main body or the corrugated tube covering the wire harness main body to be protected changes, the wire harness main body or the corrugated tube may move inside the technology and may produce noise.

In Patent Literature 2, the temporary fixation members are capable of displacement in the inward/outward direction, but when viewed overall in a length direction of the protector, the wire harness or corrugated tube cannot be claimed to be fixated in a manner free from jostling.

In Patent Literature 3, the protective material is formed by the dip-molded article, and therefore may have an issue of deteriorated path maintenance ability.

Given this, the present invention has as an object to provide a protective member which is capable of attaching to a wire harness having various outer diameters with as little jostling as possible, and which has excellent path maintenance ability.

### Means for Solving the Problems

In order to resolve the above-noted issues, a first aspect is a protective member covering and protecting an outer circumference of a wire harness main body, the protective member being formed by hot-pressing a nonwoven member, being formed in a shape covering at least a portion of the outer circumference of the wire harness main body and having an opening formed in a portion of the outer circumference, and being sufficiently elastic to enable flexure deformation toward inner and outer circumferences.

A second aspect is the protective member according to the first aspect, in which an outer circumference portion is more pliant than an inner circumference portion.

A third aspect is the protective member according to the first or second aspect, in which a projection along a circumference direction of the protective member is formed on the inner circumference.

A fourth aspect is the protective member according to any one of the first to third aspects, in which two side edge portions having the opening therebetween are formed so as to project further than a circle corresponding to an arced shape of the inner circumference portion.

A fifth aspect is the protective member according to any one of the first to fourth aspects, in which the protective member is formed in a branch shape capable of accommodating a branch portion of the wire harness main body.

A wire harness according to a sixth aspect includes a wire harness main body; a protective member according to any one of the first to fifth aspects attached to an outer circumference of the wire harness main body; and a retention member attached to an outer circumference of the protective member and maintaining the wire harness main body in a state accommodated within the protective member.

### Effect of the Invention

According to the protective member according to the first aspect, in a state where the wire harness main body is accommodated within the protective member, the protective member is configured to flexure deform toward the inner and outer circumferences and can be attached to the outer circumference of the wire harness main body. Therefore, the protective member can be attached to wire harness main bodies having various outer diameters with as little jostling as possible. In addition, by hot-pressing the nonwoven member and processing the nonwoven member to be stiff, a protective member can be provided that has superior path maintenance ability.

According to the second aspect, the inner circumference portion of the protective member is stiff, and can therefore fulfill path maintenance and protective abilities. Moreover, the outer circumference portion of the protective member is pliant, and therefore noise due to contact between the protective member and surrounding members can be inhibited.

According to the third aspect, by bringing the projection into contact with the outer circumference portion of the wire harness main body, positional drift of the corrugated tube can be inhibited.

According to the fourth aspect, more portions of the outer circumference of the wire harness main body can be protected by the protective member.

According to the fifth aspect, the path of the branch portion of the wire harness main body can be maintained and the branch portion can be protected.

According to the wire harness according to the sixth aspect, the protective member can be deformed so as to accommodate the outer diameter of wire harness main bodies having various outer diameters, and the protective member can be attached to the wire harness main body. In addition, the protective member can be attached to wire harness main bodies having various outer diameters with as little jostling as possible. Moreover, by hot-pressing the nonwoven member and processing the nonwoven member to be stiff, a protective member can be provided that has superior path maintenance ability.

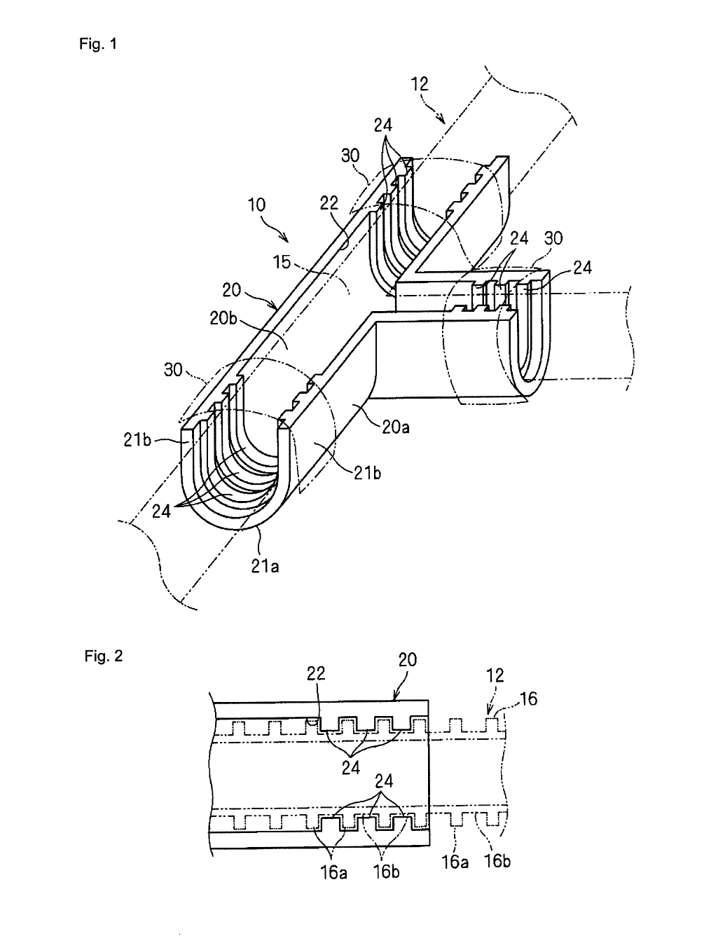

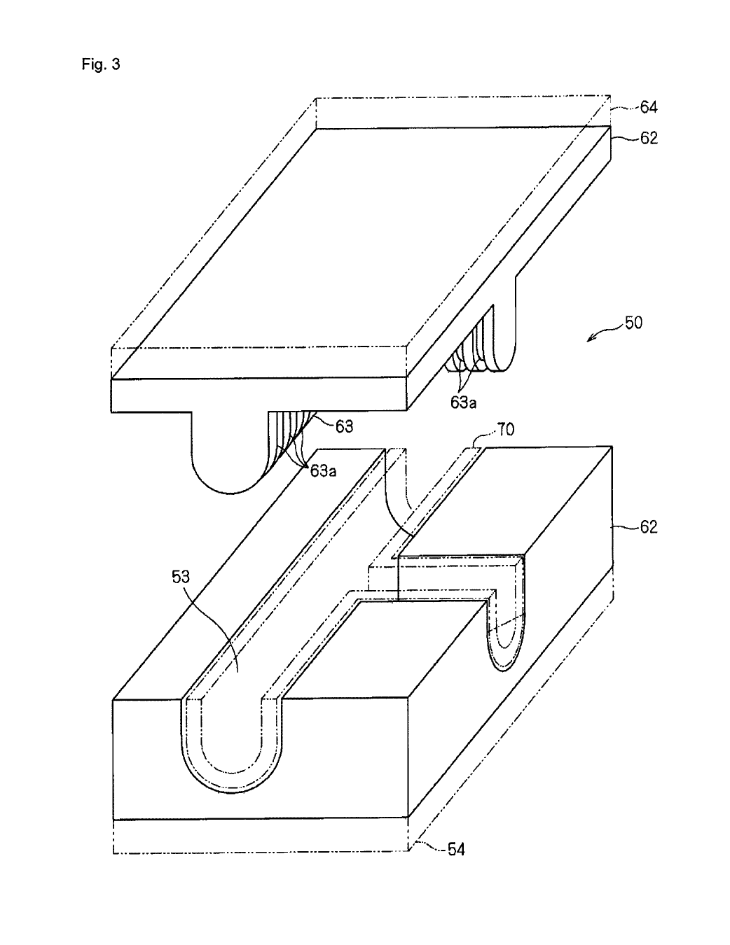

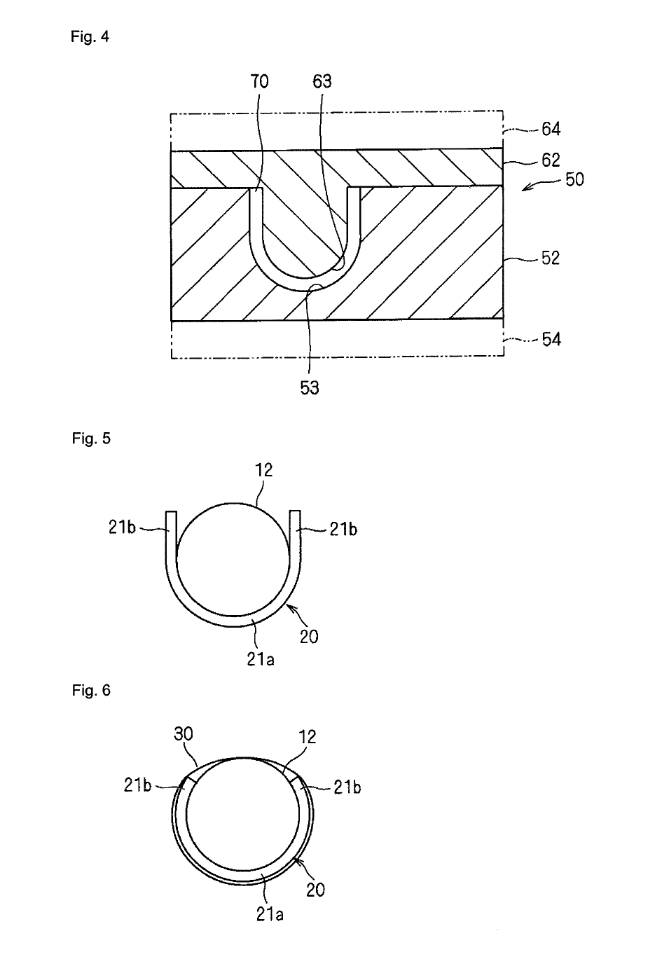

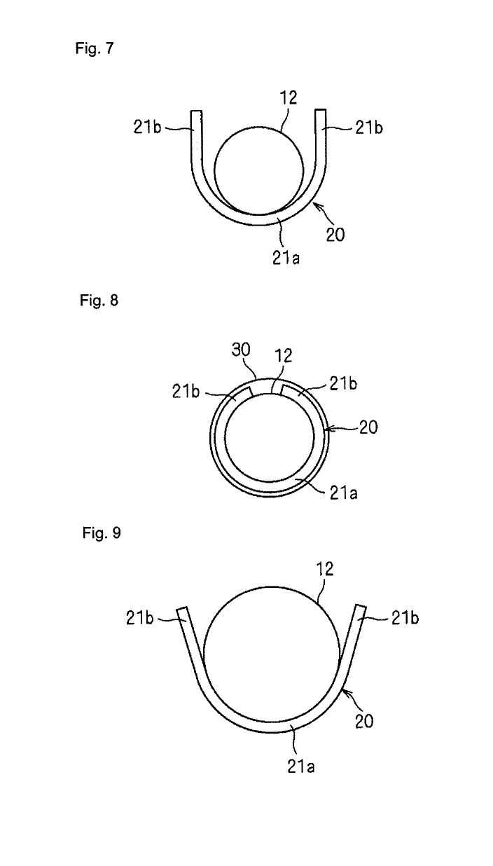

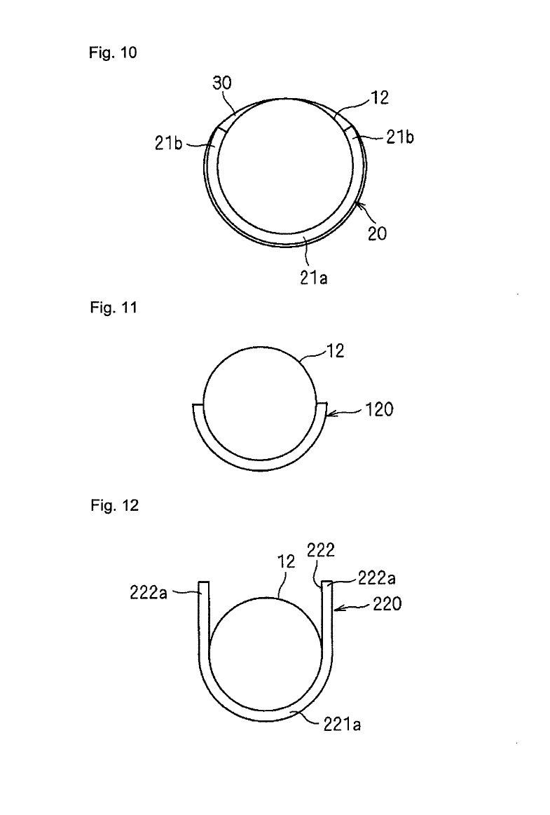

### BRIEF DESCRIPTION OF THE DRAWINGS

[FIG. 1] is a schematic perspective view of a wire harness according to an embodiment.

[FIG. 2] is an explanatory diagram illustrating a state in which a projection is fitted into an annular depression of a corrugated tube.

[FIG. 3] is an explanatory diagram illustrating an exemplary step in manufacturing a protective member.

[FIG. 4] is an explanatory diagram illustrating an exemplary step in manufacturing a protective member.

[FIG. 5] is an explanatory diagram illustrating an example of a wire harness main body accommodated within a protective member.

[FIG. 6] is an explanatory diagram illustrating an example of a wire harness main body accommodated within a protective member.

[FIG. 7] is an explanatory diagram illustrating an example of a wire harness main body accommodated within a protective member.

[FIG. 8] is an explanatory diagram illustrating an example of a wire harness main body accommodated within a protective member.

[FIG. 9] is an explanatory diagram illustrating an example of a wire harness main body accommodated within a protective member.

[FIG. 10] is an explanatory diagram illustrating an example of a wire harness main body accommodated within a protective member.

[FIG. 11] is an explanatory diagram illustrating a modified example of a protective member.

[FIG. 12] is an explanatory diagram illustrating another modified example of a protective member.

### MODE FOR CARRYING OUT THE INVENTION

In the following, a protective member and a wire harness according to an embodiment are described. FIG. 1 illustrates a schematic perspective view of a wire harness 10.

The wire harness 10 includes a wire harness main body 12, a protective member 20, and a retention member 30.

The wire harness main body 12 is configured by bundling a plurality of electric wires in a state where the electric wires branch at a branch portion 15. Herein, the branch portion 15 has a configuration in which the plurality of electric wires branch in three directions, and an example is described in which such a branch portion 15 is protected.

The branch portion may branch in a “T” shape or in a “Y” shape. In addition, the branch portion may branch in a greater number of directions, such as four. Furthermore, the wire harness main body may include other branch portions, which are not necessarily protected by the same configuration as the protective member 20 described herein.

In addition, the wire harness main body 12 includes a corrugated tube 16 mounted on a portion extending from the branch portion 15 (see FIG. 2). The corrugated tube 16 is a molded resin article having an annular projection 16a and an annular depression 16b formed alternatingly along a length direction thereof, the annular depression 16b having a smaller diameter than the annular projection 16a. By deforming a step portion located between the annular projection 16a and the annular depression 16b, the corrugated tube 16 can be readily bending deformed. The corrugated tube 16 is mounted at a fixed position on the wire harness main body 12 by wrapping adhesive tape, for example, around the corrugated tube 16 and a portion of a wire bundle. However, the wire harness main body 12 does not necessarily include the corrugated tube 16.

The protective member may also be a member protecting a non-branch portion of the wire harness main body. In such a case, the wire harness main body is not necessarily branched and may include at least one electric wire.

A plurality of electric wires is preferably bundled by an adhesive tape or the like, as needed. The wire harness main body may also include fiber optic cables and the like.

In a state where the wire harness 10 is routed along a predetermined wiring model in a vehicle, an end portion of the wire harness main body 12 is connected to various kinds of in-vehicle electronic components via a connector connection or the like. Accordingly, the in-vehicle electronic components are electrically connected to each other via the wire harness main body 12.

The protective member 20 is a member attached to the wire harness main body 12 so as to cover an outer circumference of at least a portion of the wire harness main body 12. The protective member 20 has a shape covering at least a portion of the outer circumference of the wire harness main body 12 and also includes an opening 22 formed in a portion of an outer circumference along an extension direction of the protective member 20. In addition, the protective member 20 is formed by hot-pressing a nonwoven member, and is configured to be sufficiently elastic to enable flexure deformation toward the inner and outer circumferences.

More specifically, the protective member 20 is formed in a shape that extends while branching in accordance with the extension direction of the branch portion 15 in order to protect the branch portion 15. Here, the protective member 20 is formed in a “T” shape in a plan view. A lateral cross-section shape of the protective member 20, orthogonal to an axis direction thereof, is formed in a shape capable of accommodating at least a portion of the wire harness main body 12: here, a “U” shape. More specifically, the lateral cross-section shape of the protective member 20 is formed in a shape where a pair of straight line portions 21b stand upright from two end portions of a semicircular arced portion 21a. In addition, the protective member 20 is made capable of accommodating at least a portion of the outer circumference of the wire harness main body 12 by the semicircular arced portion 21a and the pair of straight line portions 21b. Moreover, the opening 22 is formed above the pair of straight line portions 21b (an opposite side from the semicircular arced portion 21a) and the wire harness main body 12 can be accommodated within the protective member 20 through the opening 22.

A projection 24 following the circumference direction is formed on an inner circumference side of at least a portion of the axis direction of the protective member 20: here, at a plurality of end portions (three). FIG. 2 illustrates a state in which the projection 24 is fitted into the annular depression 16b of the corrugated tube 16. As shown in FIGS. 1 and 2, the projection 24 is formed in a shape capable of fitting into the annular depression 16b of the corrugated tube 16. In other words, the projection 24 is formed so as to be the same as or smaller than a width of the annular depression 16b. In addition, by fitting the projection 24 into the annular depression 16b, the corrugated tube 16 is positioned at a fixed position relative to the protective member 20.

Further, a plurality of the projections 24 are provided at intervals at each end of the protective member 20. Therefore, at each end of the protective member 20, the plurality of projections 24 are fitted into the plurality of annular depressions 16b of the corrugated tube 16, and the corrugated tube 16 is more reliably positioned at a fixed position. Also, a single projection 24 may be provided at each end.

Different types of the corrugated tube 16, in which an outer diameter, interval between the annular depressions 16b, and the like are changed, may be used to accommodate the outer diameter or the like of the wire harness main body 12 to be protected. These different types of corrugated tube 16 can be positioned using the projection 24. Therefore, the width of the projection 24 is preferably the same as or smaller than the width of the smallest annular depression 16b of the plurality of types of corrugated tube 16 to be positioned. In addition, in a case where a plurality of the projections 24 are provided, a pitch (interval centered on width direction) of each projection 24 is preferably a common multiple (preferably a least common multiple) of the pitch (interval centered on the width direction) of each annular depression 16b of the plurality of types of corrugated tube 16.

However, even in a case where the corrugated tube 16 is not provided to the wire harness main body 12, the projections 24 are able to position the wire harness main body 12 by making direct contact with the outer circumference of the wire harness main body 12. Furthermore, the projections 24 are not required to be formed on the protective member 20.

In addition, the protective member 20 is formed by hot-pressing a nonwoven member, and is sufficiently elastic to enable flexure deformation toward the inner and outer circumferences.

Herein, “hot-pressing” refers to subjecting the nonwoven member to heat treatment and forming the nonwoven member into a predetermined shape by pressing the nonwoven member against a mold. The heat treatment and the process of forming the nonwoven member into the predetermined shape may be performed simultaneously, or may be performed separately and sequentially. For example, after heating the nonwoven member, the nonwoven member can be worked into the predetermined shape by pressing the nonwoven member against a predetermined mold before the nonwoven member hardens due to cooling.

A nonwoven member capable of having at least a portion thereof melt or soften and thereafter harden through a cooling process can be used as the nonwoven member to be worked. A nonwoven member that includes elementary fibers and a binder (also referred to as an adhesive resin) can be used as such a nonwoven member. The binder is a resin having a melting point lower than that of the elementary fibers. In addition, by heating the nonwoven member to a temperature lower than the melting point of the elementary fibers and higher than the melting point of the binder, the binder melts and seeps between the elementary fibers. Thereafter, when the temperature of the nonwoven member is reduced, the binder solidifies. Accordingly, the nonwoven member can be maintained in a state molded during the heating. In addition, the solidified binder can also join locations where nonwoven members are in contact together.

The elementary fibers of the nonwoven member may be any fiber capable of maintaining a fibrous state at the melting point of the binder. Various fibers can be used other than a resin fiber, including a glass fiber and the like. Further, a thermoplastic resin fiber having a melting point lower than the melting point of the elementary fibers can be used as the binder. An exemplary combination of the elementary fibers and the binder is using a resin fiber of PET (polyethylene terephthalate) as the elementary fiber and a copolymer resin of PET and PEI (polyethylene isophthalate) as the binder.

An exemplary method of manufacturing the protective member 20 is described more specifically.

Specifically, as shown in FIGS. 3 and 4, a nonwoven member 70 is hot-pressed using a hot-press mold 50.

The hot-press mold 50 includes a lower mold 52 and an upper mold 62.

The lower mold 52 is a cuboid member formed of a metal or the like having excellent thermal conductivity. A lower mold surface 53 is formed on one principal surface (upper surface) of the lower mold 52. The lower mold surface 53 is a portion forming an outer circumferential surface of the protective member 20 and is formed in a trench shape extending in a “T” shape in a plan view and having a “U” shape in a lateral cross-section orthogonal to an axis direction. Each end of the lower mold surface 53 is open to an exterior on a lateral surface of the lower mold 52.

The upper mold 62 is a flat plate-shaped member formed of a metal or the like having excellent thermal conductivity. An upper mold surface 63 is formed on one principal surface (lower surface) of the upper mold 62. The upper mold surface 63 is a portion forming an inner circumferential surface of the protective member 20. The upper mold surface 63 extends in a “T” shape in a plan view and is formed on a surface of a projecting portion. A recess 63a is formed at a position on the upper mold surface 63 corresponding to each of the projections 24.

By arranging the upper mold surface 63 inside the lower mold surface 53, a space is created therebetween that enables the protective member 20 to be formed. Heating portions, such as a heater, 54 and 64 are provided to the lower mold 52 and the upper mold 62.

A method of performing a hot-press treatment using the above-noted hot-press mold 50 is described.

First, a sheet-shaped nonwoven member 70 is arranged inside the lower mold surface 53. The nonwoven member 70 may be a single sheet-shaped member formed in a “T” shape, or may be a plurality of sheet-shaped nonwoven members divided into a plurality of parts (for example, divided into two parts) overlapping one another at a boundary portion.

Thereafter, the upper mold surface 63 of the upper mold 62 is arranged within the lower mold surface 53 and the nonwoven member 70 is pinched between the lower mold surface 53 and the upper mold surface 63 from both surface sides. When this occurs, the nonwoven member 70 is heated, centered on portions in contact with the lower mold 52 and the upper mold 62. Accordingly, the binder within the nonwoven member 70 melts.

Thereafter, when the nonwoven member 70 is cooled, in the space between the lower mold 52 and the upper mold 62, an inner circumference surface portion of the nonwoven member 70 is cured in a shape corresponding to the shape of the upper mold surface 63 and an outer circumference surface portion of the nonwoven member 70 is cured in a shape corresponding to the shape of the lower mold surface 53. Thereafter, the protective member 20 is extracted from the hot-press mold 50.

Elasticity and rigidity of the protective member 20 is defined so as to enable the branch portion 15 and surrounding portions on the wire harness main body 12 to be kept along a predetermined path, and so as to enable the protective member 20 to be flexure deformed toward the inner and outer circumferences. The elasticity and rigidity of the protective member 20 can also be adjusted by adjusting at least one of a ratio or a melting point of the binder included in the nonwoven member 70, a degree of compression of the nonwoven member 70, a heating temperature and heating time of the nonwoven member 70, and the like.

Moreover, an outer circumference portion 20a of the protective member 20 is preferably processed to be more pliant than an inner circumference portion 20b. By processing the inner circumference portion 20b of the protective member 20 to be comparatively stiff, the rigidity necessary to maintain the path of the wire harness main body 12 and the strength (wear resistance and the like) necessary to protect the wire harness main body 12 can be imparted to the protective member 20. In addition, processing the inner circumference portion 20b of the protective member 20 to be comparatively stiff enables the projections 24 to be formed. Moreover, by processing the outer circumference portion 20a of the protective member to be comparatively pliant, the occurrence of noise due to contact between the protective member 20 and surrounding members can be inhibited.

In order to process the outer circumference portion 20a of the protective member 20 to be more pliant than the inner circumference portion 20b, during hot-pressing, the heating temperature of the outer circumference portion 20a of the protective member 20 may, for example, be set lower than the heating temperature of the inner circumference portion 20b of the protective member 20. In addition, the heating time of the outer circumference portion 20a of the protective member 20 may also be set to be shorter than the heating time of the inner circumference portion 20b of the protective member 20. Furthermore, the nonwoven member 70 may have a multi-layered structure configured by a portion forming the inner circumference portion 20b of the protective member 20 and a portion forming the outer circumference portion 20a of the protective member 20, and the binder may be configured to melt more favorably at the portion forming the inner circumference portion 20b of the protective member 20 than at the portion forming the outer circumference portion 20a of the protective member 20. For example, a ratio of the binder in the portion forming the inner circumference portion 20b of the protective member 20 may be set to be greater than the ratio of the binder in the portion forming the outer circumference portion 20a of the protective member 20, the melting point of the binder in the portion forming the inner circumference portion 20b of the protective member 20 may be set to be lower than the melting point of the binder in the portion forming the outer circumference portion 20a of the protective member 20, or the like. Naturally, each of the above-noted conditions may also be used in combination.

The retention member 30 is attached to the outer circumference of the protective member 20, and is configured to be capable of maintaining the wire harness main body 12 in a state accommodated within the protective member 20.

Here, the retention member 30 is configured by an adhesive tape (for example, a PVC (polyvinyl chloride) adhesive tape) having an adhesive layer provided to one principal surface of a band-shaped substrate material. In addition, in a state where the wire harness main body 12 is accommodated within the protective member 20, by winding the retention member 30 around the outer circumferences of the wire harness main body 12 and the protective member 20, a state is maintained in which the wire harness main body 12 is accommodated within the protective member 20. The retention member 30 is not necessarily provided over an entire length direction of the protective member 20, but is preferably provided to at least an end portion of the protective member 20.

Moreover, in addition to the adhesive tape, a bundling band or the like may be employed as the retention member.

A relationship between the protective member 20 and an outer diameter of the wire harness main body 12 is described.

FIG. 5 illustrates a scenario in which an inner diameter of the semicircular arced portion 21 a of the protective member 20 and the outer diameter of the wire harness main body 12 are identical. In such a case, the outer circumference of the wire harness main body 12 is in a state of contact along substantially an entire width direction thereof with an inner circumference portion of the semicircular arced portion 21a of the protective member 20. Therefore, by attaching the retention member 30 to the outer circumference of the protective member 20 as described above, the wire harness main body 12 is accommodated and held in a state where a gap between the wire harness main body 12 and the semicircular arced portion 21 a of the protective member 20 is made as small as possible. Accordingly, jostling of the wire harness main body 12 within the protective member 20 is inhibited. In addition, at a portion of the protective member 20 to which the retention member 30 is attached and a vicinity thereof, the inner circumferential surface of the protective member 20 is pressed into contact with the outer circumferential surface of the wire harness main body 12. Therefore, jostling of the wire harness main body 12 can be inhibited at as many portions as possible in the extension direction of the protective member 20.

Moreover, the straight line portions 21 b of the protective member 20 are in a state separated from the outer circumference of the wire harness main body 12. Given this, as shown in FIG. 6, in order to tighten the protective member 20 toward the inner circumference, the retention member 30 may be attached and the straight line portions 21b may be flexure deformed inward so as to conform to the outer circumference of the wire harness main body 12. Accordingly, more portions of the outer circumference of the wire harness main body 12 can be covered by the protective member 20 and the wire harness main body 12 can be more reliably protected.

FIG. 7 illustrates a scenario in which the outer diameter of the wire harness main body 12 is smaller than the inner diameter of the semicircular arced portion 21 a of the protective member 20. In such a case, in a state where the wire harness main body 12 is accommodated by an initial-state protective member 20, an outer circumference portion of the wire harness main body 12 is in a state of contact with a limited portion centered on a bottom of the inner circumference portion of the semicircular arced portion 21 a of the protective member 20.

Given this, as shown in FIG. 8, in order to tighten the protective member 20 toward the inner circumference, the retention member 30 is attached and the semicircular arced portion 21a is flexure deformed inward so as to reduce the inner diameter thereof. Accordingly, the semicircular arced portion 21a is brought into contact along the entire width direction thereof with the outer circumference portion of the wire harness main body 12.

Accordingly, similar to the scenario shown in FIG. 5, the wire harness main body 12 is accommodated and held in a state where a gap between the wire harness main body 12 and the semicircular arced portion 21a of the protective member 20 is made as small as possible. Therefore, jostling of the wire harness main body 12 within the protective member 20 can be inhibited and jostling of the wire harness main body 12 can be inhibited.

In addition, similarly to FIG. 6, the straight line portions 21b of the protective member 20 are also preferably flexure deformed inward so as to conform to the outer circumference of the wire harness main body 12.

FIG. 9 illustrates a scenario in which the outer diameter of the wire harness main body 12 is larger than the inner diameter of the semicircular arced portion 21 a of the protective member 20. In such a case, the protective member 20 must be spread open and the wire harness main body 12 pressed into the protective member 20 to accommodate the wire harness main body 12 within the protective member 20. In addition, in a state where the wire harness main body 12 is accommodated within the protective member 20, the semicircular arced portion 21a is flexure deformed outward so as to increase the inner diameter thereof. In such a state, the outer circumference portion of the wire harness main body 12 is in a state of contact along the entire width direction thereof with the inner circumference portion of the semicircular arced portion 21a of the protective member 20.

Therefore, by attaching the retention member 30 to the outer circumference of the protective member 20 as described above, the wire harness main body 12 is accommodated and held in a state where a gap between the wire harness main body 12 and the semicircular arced portion 21a of the protective member 20 is made as small as possible. Accordingly, similarly to the case shown in FIG. 5, jostling of the wire harness main body 12 within the protective member 20 is inhibited.

Moreover, the straight line portions 21b of the protective member 20 are in a state separated from the outer circumference of the wire harness main body 12. Given this, as shown in FIG. 10, in order to tighten the protective member 20 toward the inner circumference, the retention member 30 may be attached and the straight line portions 21b may be flexure deformed inward so as to conform to the outer circumference of the wire harness main body 12. Accordingly, more portions of the outer circumference of the wire harness main body 12 can be covered by the protective member 20 and the wire harness main body 12 can be more reliably protected.

With the protective member 20 and the wire harness 10 configured as described above, in a state where the wire harness main body 12 is accommodated within the protective member 20, the protective member 20 can be flexure deformed either toward the inner circumference or the outer circumference to match the outer diameter of the wire harness main body 12 to be accommodated, enabling the protective member 20 to be attached to the wire harness main body 12. Therefore, the protective member 20 can be attached to a wire harness main body 12 having various outer diameters with as little jostling as possible. In addition, the protective member 20 is formed by hot-pressing the nonwoven member 70 and processing the nonwoven member 70 to be stiff. Therefore, as described above, a protective member 20 can be readily provided that is capable of readily deforming toward the inner and outer circumferences and that has a superior ability to maintain the path of the wire harness main body 12.

Further, because the protective member 20 is formed by the nonwoven member 70, the protective member 20 can be made lighter. Also, attachment of the protective member 20 to the wire harness main body 12 can be performed using adhesive tape or the like. Therefore, weight reduction can be achieved even when the wire harness 10 is considered overall.

In addition, processing the inner circumference portion 20b of the protective member 20 to be stiff enables the path maintenance ability and protective ability of the protective member 20 to be made superior. Moreover, by processing the outer circumference portion 20a of the protective member 20 to be pliant, noise due to contact between the protective member 20 and surrounding members can be inhibited. In other words, processing the outer circumference portion 20a of the protective member 20 to be pliant obviates a necessity of attaching a different tape for shock absorption or the like with the purpose of noise cancellation. Therefore, reduction in the weight and cost of the wire harness 10 can be achieved.

Naturally, the outer circumference portion 20a and the inner circumference portion 20b of the protective member 20 may also be processed to the same degree of stiffness.

In addition, the projections 24 are formed within the protective member 20. Therefore, positional drift of the wire harness main body 12 can be inhibited.

The protective member 20 is formed in a shape branching in accordance with the shape of the branch portion 15. Therefore, the path of the branch portion 15 of the wire harness main body 12 can be maintained and the branch portion 15 can be protected effectively.

Moreover, a protective member may also be a member protecting a non-branch portion of a wire harness main body. In such a case, the protective member may be formed in a straight line shape or a curving shape in accordance with a path of the wire harness main body.

In the above-described embodiment, an example was described in which the vertical cross-section shape of the protective member 20 is formed in a “U” shape; however, the protective member 20 does not necessarily require such a shape. As shown in FIG. 11, the vertical cross-section shape of a protective member 120 may also be formed in a semicircular arc shape. Alternatively, the vertical cross-section shape of the protective member 120 may also be formed in a partial circular arc shape having a center angle less than or greater than 180°, or may be formed in a “V” shape. Specifically, a protective member may have a shape capable of contact around a wire harness main body in a state inhibiting jostling by flexure deforming at least a portion of an outer circumference of the protective member toward an inner circumference or an outer circumference.

In addition, as shown in FIG. 12, in a case where the vertical cross-section shape of a protective member 220 is formed in a “U” shape, two side portions 222a of the protective member 220 having an opening 222 therebetween may be formed so as to project further in a direction opposite a semicircular arced portion 221 a than a circle corresponding to a circular arced shape of an inner circumference portion of the semicircular arced portion 221a (shown in FIG. 12 as an outer form of the wire harness main body 12).

Accordingly, a portion of the wire harness main body 12 provided on an inner side of the two side portions 222a of the protective member 220 can be more reliably protected. In particular, by flexure deforming the two side portions 222a inward, the portion of the wire harness main body 12 provided on the inner side of the two side portions 222a of the protective member 220 can be more reliably protected.

In the above, the present invention is described in detail. However, the above description is, in all aspects, for exemplary purposes and the present invention is not limited by the description. Numerous modifications not given as examples are understood to be conceivable without departing from the scope of the present invention.

### DESCRIPTION OF REFERENCE NUMERALS

10 Wire harness

12 Wire harness main body

15 Branch portion

20, 120, 220 Protective member

20a Outer circumference portion

20b Inner circumference portion

22, 222 Opening

24 Projection

30 Retention member

70 Nonwoven member

22a Two side portions

1. A wire harness comprising:
a wire harness main body;
a protective member covering and protecting an outer circumference of the wire harness main body, wherein the protective member is formed by hot-pressing a nonwoven member, is formed in a “U” shape covering at least a portion of the outer circumference of the wire harness main body and having an opening formed in a portion of the outer circumference, and is sufficiently elastic to enable flexure deformation toward inner and outer circumferences; and
a retention member attached to an outer circumference of the protective member and maintaining the wire harness main body in a condition accommodated within the protective member,
wherein in a condition in which the wire harness main body is accommodated within the protective member, the wire harness main body projects further outward than two side portions of the protective member having the opening therebetween.

2. The wire harness according to claim 1, wherein the outer circumference portion of the protective member is more pliant than an inner circumference portion.

3. The wire harness according to claim 1, wherein a projection along a circumference direction of the protective member is formed on the inner circumference of the protective member.

4. The wire harness according to claim 1, wherein two side edge portions of the protective member having the opening therebetween are formed so as to project further than a circle corresponding to an arced shape of the inner circumference portion.

5. The wire harness according to claim 1, wherein the protective member is formed in a branch shape capable of accommodating a branch portion of the wire harness main body.

6. (canceled)
